(19) United States
(12) Patent Application Publication
(10) Pub. No.: US 2024/0160955 A1
(43) Pub. Date: May 16, 2024

(54) KNOWLEDGE GRAPH OPTIMIZED PROMPT FOR OPEN-DOMAIN COMMON SENSE REASONING DECISION MAKING WITH ARTIFICIAL INTELLIGENCE

(71) Applicant: NEC Laboratories America, Inc., Princeton, NJ (US)

(72) Inventors: Xujiang Zhao, Hillsborough, NJ (US); Yanchi Liu, Monmouth Junction, NJ (US); Wei Cheng, Princeton Junction, NJ (US); Haifeng Chen, West Windsor, NJ (US)

(21) Appl. No.: 18/503,517

(22) Filed: Nov. 7, 2023

Related U.S. Application Data
(60) Provisional application No. 63/424,516, filed on Nov. 11, 2022.

(51) Int. Cl. G06N 5/02; G06F 16/332

(52) U.S. Cl. CPC G06N 5/02; G06F 16/3329

(57) ABSTRACT

A computer-implemented method for optimized decision making that includes labeling text data extracted from an inquiry, and linking labeled text to a knowledge graph entity. The method may further include retrieving from the knowledge graph reasoning paths; and removing irrelevant knowledge graph reasoning paths using a language model trained artificial intelligence consistent with the labeling of the text data. The method may further include employing remaining relevant graph reasoning paths to provide an answer prediction.

### RELATED APPLICATION INFORMATION

This application claims priority to 63/424,516, filed on Nov. 11, 2022, incorporated herein by reference in its entirety.

### BACKGROUND

### Technical Field

The present invention relates to artificial intelligence, and more particularly to employing smart graphs for decision making.

### Description of the Related Art

Large-scale pretrained language models (PLMs) learn to implicitly encode basic knowledge about the world by training on an extremely large collection of general text corpus and refining on downstream datasets, which have recently taken over as the primary paradigm in natural language processing (NLP). Although pretrained language models (PLMs) have excelled in many downstream tasks, it has been determined that they can face two major cruxes in reasoning-related tasks: 1) pretrained language models (PLMs) frequently encounter difficulties when the required knowledge is absent from the training corpus or the test instances are not formulated as question-answering format, and 2) pretrained language models (PLMs) base their predictions on implicitly encoded knowledge that is incapable of handling structured reasoning and does not offer explanations for the chosen response.

### SUMMARY

According to an aspect of the present invention, a method is provided for optimized decision support. In one embodiment, the computer-implemented method for decision support includes labeling text data extracted from an inquiry; and linking labeled text to a knowledge graph entity. The computer-implemented method may further include retrieving knowledge graph reasoning paths from the knowledge graph entity. The computer implemented method may further include removing irrelevant knowledge graph reasoning paths using a language model trained artificial intelligence consistent with the labeling of the text data. Finally, the computer implemented method can employ remaining relevant knowledge graphs to an answer prediction to the inquiry.

According to another aspect of the present invention, a system is provided for optimized decision support. The system may include a hardware processor; and a memory that stores a computer program product. The computer program product when executed by the hardware processor, causes the hardware processor to label text data extracted from an inquiry; and link labeled text to a knowledge graph entity. The computer program product can also retrieve, using the hardware processor knowledge graph reasoning paths from the knowledge graph entity; and can remove irrelevant knowledge graph reasoning paths using a language model trained artificial intelligence consistent with the labeling of the text data. Finally, using the hardware processor, the system can also employ the remaining relevant knowledge graphs to provide an answer prediction to the inquiry.

According to yet another embodiment of the present invention, a computer program product for optimized decision making is described. The computer program product includes a computer readable storage medium having computer readable program code embodied therewith. The program instructions are executable by a processor to cause the processor to label text data extracted from an inquiry; and link labeled text to a knowledge graph entity. The computer program product can also retrieve, using the hardware processor knowledge graph reasoning paths from the knowledge graph entity; and can remove irrelevant knowledge graph reasoning paths using a language model trained artificial intelligence consistent with the labeling of the text data. Finally, the computer program product can also employ the remaining relevant knowledge graphs to provide an answer prediction to the inquiry.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram illustrating an exemplary environment for knowledge based open domain common sense reasoning.

FIG. 2 illustrates one embodiment of a knowledge enhanced prompting method that can solve open domain common sense reasoning problems and can answer questions without providing any answer candidates.

FIG. 3 is a block/flow diagram illustrating one embodiment of a computer implemented method of decision support that employs knowledge based open domain common sense reasoning, in accordance with an embodiment of the present invention.

FIG. 4 is a block diagram illustrating a system for decision support that employs knowledge based open domain common sense reasoning, in accordance with an embodiment of the present invention.

FIG. 5 is an illustration of knowledge graph expansion with iterative reasoning steps, in accordance with one embodiment of the present disclosure.

FIG. 6 is an illustration depicting a knowledge statement transformation and close-based prompt construction, in accordance with one embodiment of the present disclosure.

### DETAILED DESCRIPTION OF PREFERRED EMBODIMENTS

In accordance with embodiments of the present invention, systems and methods are provided to approach open domain common sense reasoning via an external knowledge base. For example, given a natural text question (also known as inquiry), the computer implemented methods, systems and computer program products of the present disclosure can answer the question without providing any answer candidates and fine tuning examples. The computer implemented methods, systems and computer program products provide optimized decision making that employs artificial intelligence principles that can be suitable for application in healthcare, medical care, physical care and disease treatment, etc.

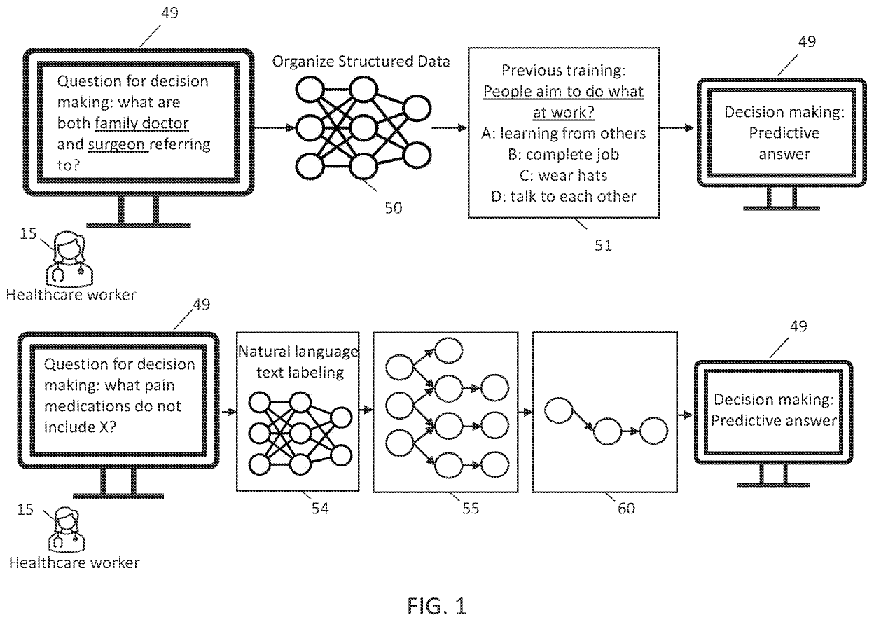

FIG. 1 illustrates when a pretrained language model (PLM) 50 is presented with a question that its domain is different from examples seen during the training. In the example illustrated in FIG. 1, the pretrained language model (PLM) artificial intelligence could provide multiple-choice question and answer scenarios 51 and calculate the likelihood of the whole sentence by filling in the blank with each answer candidate. However, both answers employ learning from others and complete job can fit in the semantics of the question. Pretrained language model (PLMs) generally cannot provide justification for why a certain answer can be chosen. FIG. 1 illustrates that the prediction of common sense reasoning previously relied upon robust and structured reasoning to integrate the explicit information offered by the question context and external knowledge.

FIG. 1 illustrates that it has been determined that there are two cruxes of using pretrained language model (PLMs) in common sense reasoning: 1) Without finetuning, pretrained language model (PLMs) in may not handle out-of distribution or domain-specific reasoning questions; and 2) Pretrained language model (PLMs) in generally rely up pre-existing answer candidates and they generally cannot justify their prediction results.

The computer implemented methods, systems and computer program products, we focus on the open-domain common sense reasoning task, which includes that the machine learning model makes a presumptions about the type and essence of ordinary situations without presenting any answer candidates and finetuning examples, e.g., without the multiple-choice question and answer scenarios identified by reference number 51 in FIG. 1.

The computer implemented methods, systems and computer program products described herein leverages neural language models to iteratively retrieve reasoning chains on an external knowledge base, which does not require task-specific supervision, e.g., does not require training using candidate answers with a multiple choice format. The reasoning chains can help to identify the most precise answer to the common sense question and its corresponding knowledge statements to justify the answer choice.

Referring back to FIG. 1, in some embodiments, to provide a knowledge based open domain common sense reasoning, the method and systems may employ three components: 1) entity extraction and linking, 2) local knowledge graph expansion, and 3) explanation generation and answer prediction. Entity extraction and linking may be provided by a natural language model 54 that is pretrained to extract and label text from inquiries. Any inquiry, e.g., question, may be submitted to the computer implemented methods and systems, however, in some embodiments, the inquires may be related to the medical and healthcare field. The inquiry may be entered into the system by a healthcare professional 15, such as a nurse or doctor, or the inquiry may be entered into the system by a patient in a healthcare environment. The inquiry can be entered by a healthcare professional, such as a doctor, paramedical professional, nurse, medical worker, health professional, health practitioner, medical service worker, etc.

For example, the inquiries may be for decision support in running a medical facility, a pharmacy, or a rehabilitation center. In some examples, the inquiries may be decision treatment on patients. In some examples, the inquiries may be entered by a health care professional that is using the computer implemented methods and systems to obtain information about medicines or treatments for patients and to do medical interviews. In some examples, the inquiries may be entered be entered by a patient that is using the system to obtain information about medicines or treatments that are prescribed to them, such as cancer treatments. The computer implemented methods, systems and computer program products that are described herein can also be used to support the user in decision making applications. For example, medical professionals can decide medicines or treatments for patients dealing with sickness. Patients can decide whether they agree with prescribed medicines or treatments.

In the example depicted in FIG. 1, the question being asked can be directed to the composition of pain medications, and can serve as an example of decision support/decision making for hospital administration, stocking appropriate medications.

In the example depicted in FIG. 1, the question being asked is directed to the composition of pain medications, and can serve as an example of decision support/decision making for a pharmacist, stocking appropriate medications and/or checking medications for suitability to patients.

In the example depicted in FIG. 1, the question being asked is directed to the composition of pain medications, and can serve as an example of decision support/decision making for a doctor or nurse can be used in the treatment of a patient.

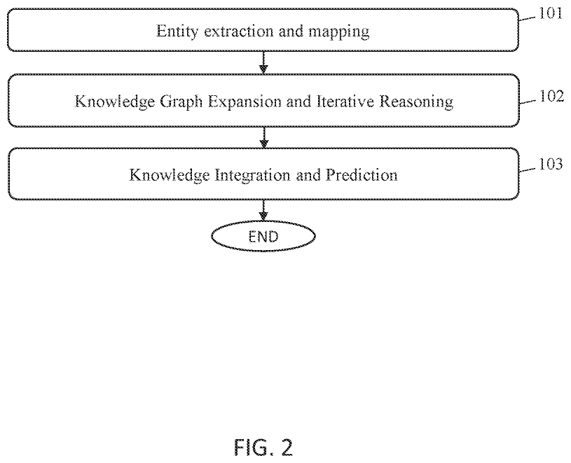

FIG. 2 illustrates one embodiment of a knowledge enhanced prompting method that can solve open domain common sense reasoning problems and can answer questions without providing any answer candidates. In some examples, the flow illustrated in FIG. 2 can address an open-domain common sense reasoning problem on text data, as it can provide a new knowledge enhanced prompting framework that utilizes the implicitly stored knowledge in pretrain language models (PLMs) to iteratively recover reasoning chains from the organized external knowledge base, as opposed to alternative methods that need direct supervision of the reasoning processes. Additionally, each retrieved reasoning path acts as the explicit justification for the answer selection. In order to achieve the goal, the framework follows the procedure illustrated in blocks 101-103.

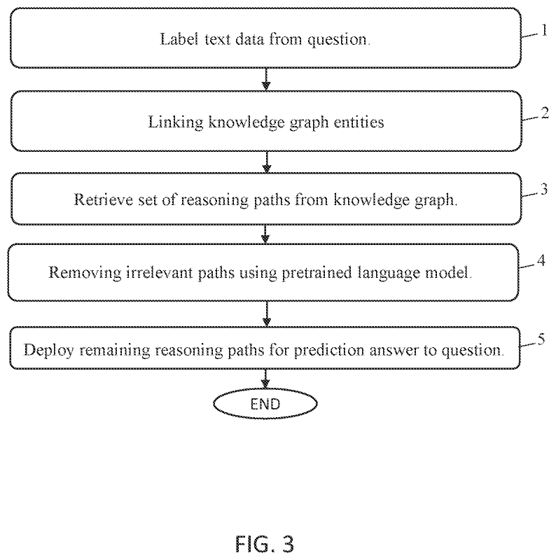

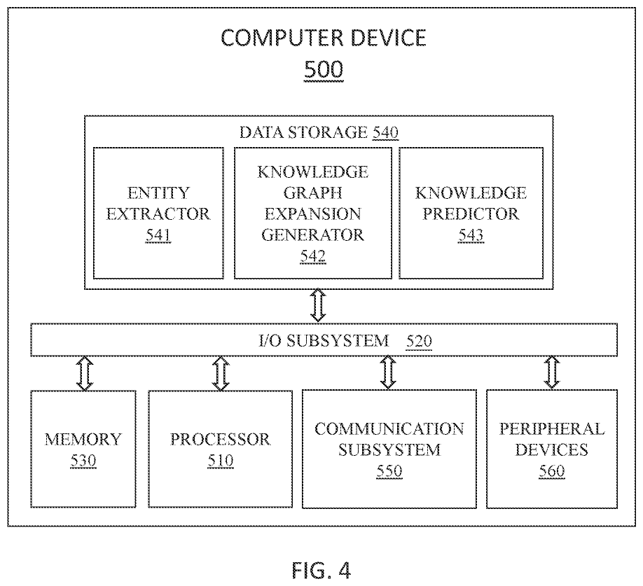

Referring first to block 101, the computer implemented methods, systems and computer program products described herein can leverage knowledge that connects words and phrases of natural language with labeled edges to extract a set of critical entities from the text question that have the surjective mapping to nodes in a knowledge graph. A “knowledge graph”, also known as a semantic network, represents a network of real-world entities—i.e. objects, events, situations, or concepts—and illustrates the relationship between them. This information is usually stored in a graph database and visualized as a graph structure, prompting the term knowledge “graph.” A knowledge graph is made up of three main components: nodes, edges, and labels. Any object, place, or person can be a node. An edge defines the relationship between the nodes. Block 101 of FIG. 2 is further described below in greater detail with reference to block 1 of the detailed method described in FIG. 3. Further, the functions described by block 101 of FIG. 2, and block 1 of FIG. 3, can be performed by an entity extractor 541, as illustrated in the computing device 500 that is depicted in FIG. 4.

Referring to block 102 of FIG. 2, the computer implemented methods and systems can aim to retrieve reasoning paths from the knowledge graph within L hops from knowledge graph to form the local knowledge subgraph that has the highest coverage to the question concepts. In addition to making the process of reasoning path expansion scalable, it incorporates the implicit knowledge in PLMs to prune irreverent paths. Block 102 of FIG. 2 is further described below in greater detail with reference to blocks 2 and 3 of the detailed method described in FIG. 3. Further, the functions described by block 102 of FIG. 2, and blocks 2 and 3 of FIG. 3, can be performed by a knowledge graph expansion generator 542, as illustrated in the computing device 500 that is depicted in FIG. 4.

Referring to block 103 of FIG. 2, the computer implemented methods and systems can then consider that all the reasoning paths can be regarded as the supporting knowledge explanation, and the computer implemented methods and systems can aim to make the answer prediction. For example, a beam search many be utilized to only keep high-confidence reasoning paths and transform them into natural language by the designed template in the set of knowledge statements during the retrieval phase. In some embodiments, a beam search can be a heuristic search algorithm that explores a graph by expanding the most promising node in a limited set. Beam search is an optimization of best-first search that reduces its memory requirements. Best-first search is a graph search which orders all partial solutions (states) according to some heuristic. But in beam search, only a predetermined number of best partial solutions are kept as candidate. Block 103 of FIG. 2 is further described below in greater detail with reference to blocks 4 and 5 of the detailed method described in FIG. 3. Further, the functions described by block 103 of FIG. 2, and blocks 4 and 5 of FIG. 3, can be performed by a knowledge predictor 543, as illustrated in the computing device 500 that is depicted in FIG. 4.

FIG. 3 illustrates one embodiment of a computer implemented method of decision support/decision making that employs knowledge based open domain common sense reasoning using artificial intelligence. Block 1 can include labeling text data extracted from an inquiry. For example, the inquiry can be a question that is entered into the system that is a question that the user 15 is seeking support on. For example, the inquiry can be typed into an interface of a computing systems 49 that provides the input to the system, and the inquiry can be in text, e.g., sentence, form. As noted above, the inquiry can be subject matter that is relevant to medical care and/or administration of medical care facilities.

FIG. 4 is a block diagram illustrating a system for decision support that employs knowledge based open domain common sense reasoning. The inquiry can be entered into the system using peripheral interfaces 560, which can include any number of additional input/output devices, such as those having a keyboard for data entry.

Referring back to block 1 of FIG. 2, in some embodiments, to label the text data, a text data corpus is selected. In some embodiments, the text data corpus is created from question-answer text and includes a set of strongly labeled data with multiple choice answers. In some embodiments, natural language processing is used to perform the labeling text data at block 1 of the computer implemented method using a model trained with the text data corpus. In some examples, the terms selected from the question and answer inquiries including medical topics selected from group consisting of medications and compositions thereof, diagnosis and treatments thereof, medical staff titles and responsibilities thereof, medical building classifications and stock contents thereof, and combinations thereof.

In some embodiments, the functions described by block 1 of FIG. 3, can be performed by an entity extractor 541, as illustrated in the computing device 500 that is depicted in FIG. 4.

In some embodiments, the computer implemented methods can solve open-domain common sense reasoning questions using knowledge from a pre-trained language (PLM) and a structured knowledge graph G. The knowledge graph G=(V, E) is a multi-relational graph, where V is the set of entity nodes, E⊆V×R>V is the set of edges that connect nodes in V, where R represents a set of relation types.

In some embodiments, for open-domain commonsense reasoning questions q (i.e., given a question q without providing answer candidates), the target of this work is to determine 1) a local knowledge graph G_{q}∈G contains relevant information of q; 2) a set of knowledge statements k={k₁, k₂, . . . , kₘ}; and 3) an entity â extracted from k that is precise to answer the question q.

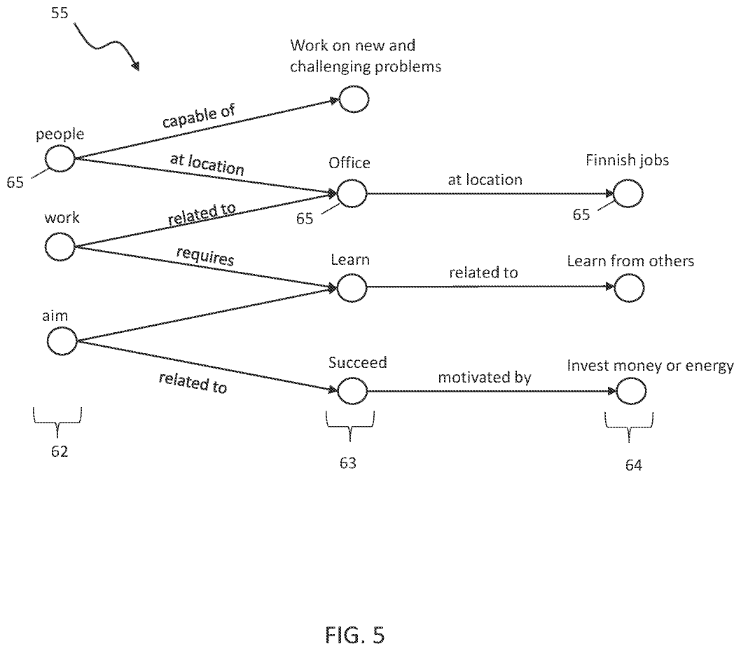

For example, to answer the opendomain common sense question “what do people aim to do at work?”, the systems first aim at first extracting all plausible knowledge statements from the external knowledge base that can provide logical information to answer the question. Starting with concept extraction and mapping, the questions concepts may be “people”, “work”, and “aim”. These provide the initial entities identified by reference number 62 in FIG. 5.

FIG. 5 illustrates the step of graph expansion with iterative reasoning steps, i.e., first hoop expansion 63 and second hoop expansion 64, for the question “what do people aim to do at work”. Among all the statements, the system selects the most precise one, as indicated by the nodes having reference number 65. In the example depicted in FIG. 5 the most precise statement is “people learn to work at the office to finish jobs”. From this, an answer is extracted as follows: â=finish_jobs such that the following joint likelihood can be maximized.

P(â,k|q,G_{q})=P(k|q,G_{q})·P(â|k) Equation (1)

Referring to block 2 of FIG. 3, the computer implemented method may continue to knowledge graph entity linking. In this step, a knowledge base (e.g., a knowledge graph) is to extract the set of critical entities from the text question. In some embodiments, linking the text to the knowledge graph entity includes a knowledge graph that connects words and phrases of natural language with labeled edges.

In some embodiments, knowledge graph entity linking can include a knowledge graph that can enables a variety of useful context-oriented reasoning tasks over realworld texts, which provides structured knowledge in the open-domain common sense reasoning task.

To reason over a given common sense context using knowledge from both the pretrained learning model (PLM) and the knowledge graph G, the first step of the framework is to extract the set of critical entities c_{q}={c_{q}⁽¹⁾, . . . , c_{q}⁽ⁱ⁾, . . . } from the question q that have the surjective mapping to nodes V_{q}∈V in the knowledge graph. Because the question q is often presented in the form of non-canonicalized text and contains fixed phrases, the computer implemented methods and systems can map informative entities c_{q} from the question q to conjunct concept entities in the knowledge graph by leveraging the latent representation of the query context and relational information stored in G.

Further, the functions described by block 2 of FIG. 3 can be performed by a knowledge graph expansion generator 542, as illustrated in the computing device 500 that is depicted in FIG. 4.

Referring to block 3 of FIG. 3, the computer implemented method may continue with retrieving set of reasoning paths from knowledge graph 55. Referring back to FIG. 1, a reasoning path is identified by reference number 60. The reasoning path 60 illustrated in FIG. 1 is a relevant reasoning path following pruning of the irrelevant reasoning paths, which are all extracted from the knowledge graph.

Referring to block 3 of FIG. 3 and FIG. 1, the step of retrieving the set of reasoning paths 60 may be referred to a reasoning over a local knowledge graph. The computer implemented methods and systems can aim to retrieve reasoning paths within L hops from G to form the local knowledge subgraph. Referring to FIG. 5, examples of L hops on a knowledge graph are illustrated by reference numbers 62 and 63.

In some embodiments, each path in G_{q} can be regarded as a reasoning chain that helps to locate the most precise answer and its explanation to the question q. However, expanding L-hop subgraph G_{q} from c_{q} is computationally prohibited. The open-domain common sense reasoning problem does not provide any directions. More specifically, in some embodiments, the open-domain common sense reasoning problem does not provide any answer candidates. The typical node size of a 3-hop local knowledge graph with |c_{q}|=3 could easily reach 1,000 on a knowledge graph.

Further, the functions described by block 3 of FIG. 3, can be performed by a knowledge graph expansion generator 542, as illustrated in the computing device 500 that is depicted in FIG. 4.

Referring to block 4 of FIG. 3, the computer implemented method may continue with removing irrelevant knowledge graph reasoning paths using a language model trained consistent with the labeling of the text data. In some embodiments, this step may be referred to as reasoning path pruning. In some embodiments, during reasoning path pruning, the computer implemented methods and systems can incorporate the implicit knowledge in pretrain language model to prune irreverent paths to make the process of reasoning path expansion scalable. Further, the functions described by block 4 of FIG. 3, can be performed by the knowledge predictor 543, as illustrated in the computing device 500 that is depicted in FIG. 4.

In some embodiments, the computer implemented methods and systems pair the question q with the text of node v along with the reasoning-path-transformed knowledge statement to form a doze-based prompt W=[q; vⱼ;(vᵢ, rᵢⱼ, vⱼ)] in order to turn the local graph expansion problem into an explicit reasoning procedure by directly answering the question with explanation.

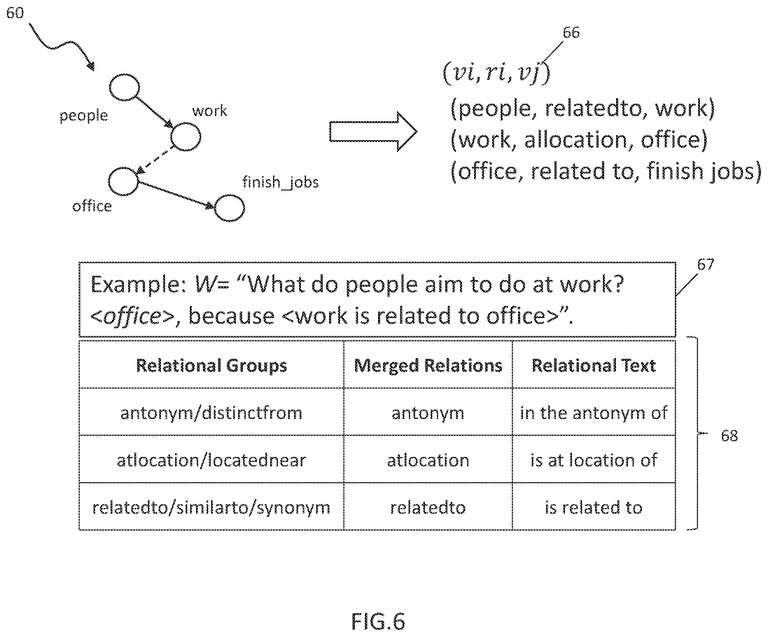

For example, in FIG. 6, a knowledge statement transformation and close-based prompt constructions is depicted. The prompt is formatted as:
What do people aim to do at work? <node>, because <reasoning path>.

A reasoning path is depicted by reference number 60 for the example questions “What do people aim to do at work?” 67. Note that the computer implemented methods and systems can leverage a predefined template to transform the triplet (vᵢ, rᵢⱼ, vⱼ) 66 into natural language, e.g., relational text as illustrated in the table having reference number 68. In some examples, the relational graph 55 contains lots of relations, and some of them share similar meanings, e.g., both antonym and distinct from have the same meaning antonym, as illustrated in the table having reference number 68.

The computer implemented methods and systems can employ predefine templates, such as those in table 68, to transform the reasoning path triplets into natural language. For example, (work, antonym, unemployment) can be translated to work is the antonym of unemployment. The table identified by reference number 68 also illustrates a few examples of the merged types and templates in FIG. 6.

Referring back to removing irrelevant knowledge graph reasoning paths in accordance with block 4 of FIG. 3, to evaluate whether a reasoning path is kept or removed, the computer implemented methods and systems compute the common sense score of the reasoning path 60. For example, a pre trained learning model (PLM) can be used to score the relevance of each reasoning path given the context of the question q.

For example, when the logical sentence W consists of N words W={ω₁, ωₙ₋₁, ωₙ, ωₙ₊₁, . . . , ω_{N}}, the common sense score ϕₗ(W) of the logical sentence W composed at l-th hop expansion can be defined as:

ϕₗ(W):=Σₙ₌₁^{N} log(p_{θ}(ωₙ|W_{\n}))/N Equation (2)

where the W_{\n} indicates the masked knowledge statement by replacing the token ωₙ to the mask, and the denominator N reduces the influence of the sentence length on the score prediction. Intuitively, log (p₇₄ (ωₙ|W_{\n})) can be interpreted as how probable a word ωₙ given the context. For example, by filling blue and red into the masked logical statement W_{\n}=The sky is [MASK], blue should have a higher score.

As the computer implemented methods and systems iteratively expand G_{q}, each ϕₗ(W) scores a unique reasoning path at a particular l∈[1, L] depth in the graph. In some embodiments, a higher score ϕₗ(W) indicates the node vⱼ should be kept for the next (l+1) hop expansion.

Turning to block 5 of FIG. 3, the computer implemented methods may continue with employing the remaining relevant graph reasoning paths, i.e., following pruning in block 4, to provide an answer prediction. Block 5 may be referred to as a knowledge integration and prediction step. In this step, a beam search is utilized to only keep high-confidence reasoning paths and transform them into natural language to make the final answer prediction. The functions described by block 5 of FIG. 3, can be performed by the knowledge predictor 543, as illustrated in the computing device 500 that is depicted in FIG. 4.

In some embodiments, after the subgraph G q consisting of all reasoning paths within L-hop with a high common sense score is obtained, all of the reasoning paths 60 can be regarded as the supporting knowledge explanation. The final step can be to make the answer prediction. In some embodiments, beam search can be employed to only keep high-confidence reasoning paths and transform them into natural language by the designed template in the set of knowledge statements k during the retrieval phase. Starting from each entity in question concepts c a , each reasoning path within L-hop neighbor can then be seen as scoring a path to a particular answer node.

$$log {p}_{θ} ( a \vert [ q ; k ] ) ∝ {ϕ}_{L} = {\sum }_{l = 1}^{L} {ϕ}_{l} ; ( \hat{a} , \hat{k} ) = {arg max}_{a ∈ a , k ∈ k} {ϕ}_{L} \qquad Equation ( 3 )$$

where a is the set of all explored answer candidates, and the ϕ_{L} denotes the final score for each answer and can be interpreted as approximating the likelihood of answer a given a singular reasoning path {c→v₁→v₂→ . . . →a}. The methods and systems can thus provide the answer â and its explanation \hat{k} with the highest score as the final answer and supporting knowledge.

Referring back to the example depicted in FIG. 5, for the question q=“what do people aim to do at work?”, having question concepts c_{q} of “people”, “work” and “aim”, knowledge integration and prediction can provide cₖ={“work on new and challenge problems”, “finish jobs”, “learn from others”, “invest money or energy”, . . . }, which when converted to language text using natural language processing, can provide a final answer of k={“People is capable of work on new and challenge problems”, “work is related to office, office is at the location of finish jobs”, “work requires learn, learn is related to learn from others”, and “aim is related to succeed, succeed is motivated by invest money or energy”}.

It is noted that the example described in the preceding paragraph is only one example, and the present disclosure is not limited to only that example. In some embodiments, the answer prediction 19 is selected from the group consisting of stocking medications according to composition, assigning office locations by job function according to application of medical buildings, and treatment assignment to diagnosis characteristics. Referring back to FIG. 1, the predictive answer 19 may be displayed to the user 15, e.g., health care worker, doctor, nurse, patient etc., over a display of the interface 19 through which the user 15 interacts with the system.

In one embodiment, the computer implemented methods and systems described with reference to FIGS. 1-6 can provide an open-domain commonsense reasoning method (KEP) to answer text questions without providing any answer candidates and finetuning examples. In some embodiments, the KEP iteratively collects reasoning chains from the external structured knowledge base using the implicit information stored in pretrain language model as guidance. In some embodiments, the KEP is capable of both identifying the most appropriate answer and automatically producing the explanations that support the choice.

Referring now to FIG. 4, an exemplary computing device 500 is shown, in accordance with an embodiment of the present invention. The computing device 500 can be configured to provide decision support. For example, the system for decision support may include a hardware processor 510; and a memory 530 that stores a computer program product. The memory 530 may include data storage 540. The data storage 540 may include an entity extractor 541, a knowledge graph expansion generator 542, and a knowledge predictor 543.

The contents of the data storage 540 when executed by the hardware processor 510, causes the hardware processor 510 to label text data extracted from an inquiry; link labeled text to a knowledge graph entity; and retrieve from the knowledge graph reasoning paths. The entity extractor 541 may perform the step of label text data being extracted from an inquiry. The knowledge graph expansion generator 542 can perform the steps of linking labeled text to a knowledge graph entity; and retrieving from the knowledge graph reasoning paths. There functions are described in greater detail above in block 102 of FIG. 2 and block 2 of FIG. 3. The knowledge graph expansion generator 542 may also remove irrelevant knowledge graph reasoning paths using a language model trained consistent with the labeling of the text data. This feature is described in greater detail above in block 102 of FIG. 2 and block 5 of FIG. 3. The knowledge predictor 543 can employ remaining relevant graph reasoning paths to provide an answer prediction. This feature is described above with reference to block 103 of FIG. 2 and block 5 of FIG. 3.

The computing device 500 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 500 may be embodied as one or more compute sleds, memory sleds, or other racks, sleds, computing chassis, or other components of a physically disaggregated computing device.

As shown in FIG. 4, the computing device 500 illustratively includes the processor 510, an input/output subsystem 520, a memory 530, a data storage device 540, and a communication subsystem 550, and/or other components and devices commonly found in a server or similar computing device. The computing device 500 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 530, or portions thereof, may be incorporated in the processor 510 in some embodiments.

The processor 510 may be embodied as any type of processor capable of performing the functions described herein. The processor 510 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 530 may be embodied as any type of volatile or non-volatile memory or data storage capable of performing the functions described herein. In operation, the memory 530 may store various data and software used during operation of the computing device 500, such as operating systems, applications, programs, libraries, and drivers. The memory 530 is communicatively coupled to the processor 510 via the I/O subsystem 520, which may be embodied as circuitry and/or components to facilitate input/output operations with the processor 510, the memory 530, and other components of the computing device 500. For example, the I/O subsystem 520 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 520 may form a portion of a system-on-a-chip (SOC) and be incorporated, along with the processor 510, the memory 530, and other components of the computing device 500, on a single integrated circuit chip.

The data storage device 540 may be embodied as any type of device or devices configured for short-term or long-term storage of data such as, for example, memory devices and circuits, memory cards, hard disk drives, solid state drives, or other data storage devices. The data storage device 540 can store program code for the entity extractor 541, the knowledge graph expansion generator 542, and the knowledge predictor 543.

Any or all of these program code blocks may be included in a given computing system. The communication subsystem 550 of the computing device 500 may be embodied as any network interface controller or other communication circuit, device, or collection thereof, capable of enabling communications between the computing device 500 and other remote devices over a network. The communication subsystem 550 may be configured to use any one or more communication technology (e.g., wired or wireless communications) and associated protocols (e.g., Ethernet, InfiniB and®, Bluetooth®, Wi-Fi®, WiMAX, etc.) to effect such communication.

As shown, the computing device 500 may also include one or more peripheral devices 560. The peripheral devices 560 may include any number of additional input/output devices, interface devices, and/or other peripheral devices. For example, in some embodiments, the peripheral devices 560 may include a display, touch screen, graphics circuitry, keyboard, mouse, speaker system, microphone, network interface, and/or other input/output devices, interface devices, and/or peripheral devices.

Of course, the computing device 500 may also include other elements (not shown), as readily contemplated by one of skill in the art, as well as omit certain elements. For example, various other sensors, input devices, and/or output devices can be included in computing device 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 500 are readily contemplated by one of ordinary skill in the art given the teachings of the present invention provided herein.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. For example, a computer program product may be provided for decision support. The computer program product may a computer readable storage medium having computer readable program code embodied therewith, the program instructions executable by a processor to cause the processor to label text data extracted from an inquiry; and link labeled text to a knowledge graph entity. The computer program product can also retrieve, using the processor, from the knowledge graph reasoning paths; and remove, using the processor, irrelevant knowledge graph reasoning paths using a language model trained consistent with the labeling of the text data. The computer program product can also employ, using the processor, remaining relevant graph reasoning paths to provide an answer prediction.

A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for decision making comprising:
labeling text data extracted from an inquiry;
linking labeled text to a knowledge graph entity;
retrieving knowledge graph reasoning paths from the knowledge graph entity;
removing irrelevant knowledge graph reasoning paths using a language model trained consistent with labeling of the text data; and
employing remaining relevant graph reasoning paths to provide an answer prediction to the inquiry.

2. The computer-implemented method of claim 1, wherein the answer prediction is selected from the group consisting of stocking medications according to composition, assigning office locations by job function according to application of medical buildings, and treatment assignment to diagnosis characteristics.

3. The computer-implemented method of claim 1, wherein the text data extracted from the inquiry comprises collecting a text data corpus of question and answer text from multiple choice questions, and using natural language processing to perform the labeling text data using an artificial intelligence model trained with the text data corpus.

4. The computer-implemented method of claim 3, wherein terms selected from the question and answer text include medical topics selected from group consisting of medications and compositions thereof, diagnosis and treatments thereof, medical worker titles and responsibilities thereof, medical building classifications and stock contents thereof, and combinations thereof.

5. The computer-implemented method of claim 1, wherein linking the text to the linking labeled text to the knowledge graph entity comprises a knowledge graph that connects words and phrases of natural language with labeled edges.

6. The computer-implemented method of claim 1, wherein the employing of the remaining relevant knowledge graphs to provide the answer prediction comprises using a beam search to determine a highest confidence reasoning path.

7. The computer-implemented method of claim 6 further comprising using natural language processing artificial intelligence to make a highest confidence reasoning path the answer prediction in natural language.

8. A system for decision making comprising:
a hardware processor; and
a memory that stores a computer program product, which, when executed by the hardware processor, causes the hardware processor to:
label text data extracted from an inquiry;
link labeled text to a knowledge graph entity;
retrieve knowledge graph reasoning paths from the knowledge graph entity;
remove irrelevant knowledge graph reasoning paths using a language model trained artificial intelligence consistent with the labeling of the text data; and
employ remaining relevant graph reasoning paths to provide an answer prediction to the inquiry.

9. The system of claim 8, wherein the answer prediction is selected from the group consisting of stocking medications according to composition, assigning office locations by job function according to application of medical buildings, and treatment assignment to diagnosis characteristics.

10. The system of claim 8, wherein the labeling the text data extracted from the inquiry comprises collecting a text data corpus of question and answer text from multiple choice questions, and using natural language processing to perform the labeling text data using a model trained with the text data corpus.

11. The system of claim 10, wherein terms selected from the question and answer text include medical topics selected from group consisting of medications and compositions thereof, diagnosis and treatments thereof, medical worker titles and responsibilities thereof, medical building classifications and stock contents thereof, and combinations thereof.

12. The system of claim 8, wherein linking the text to the linking labeled text to the knowledge graph entity comprises a knowledge graph that connects words and phrases of natural language with labeled edges.

13. The system of claim 8, wherein the employing of the remaining relevant knowledge graphs to provide the answer prediction comprises using a beam search to determine a highest confidence reasoning path.

14. The system of claim 13 further comprising using natural language processing artificial intelligence to make the highest confidence reasoning path the answer prediction in natural language.

15. A computer program product for decision making, the computer program product comprises a computer readable storage medium having computer readable program code embodied therewith, the program instructions executable by a processor to cause the processor to:
label, using the processor, text data extracted from an inquiry;
link, using the processor, labeled text to a knowledge graph entity;
retrieve, using the processor, knowledge graph reasoning paths from the knowledge graph entity;
remove, using the processor, irrelevant knowledge graph reasoning paths using a language model trained artificial intelligence consistent with the labeling of the text data; and
employ, using the processor, remaining relevant graph reasoning paths to provide an answer prediction to the inquiry.

16. The computer program product of claim 15, wherein the answer prediction is selected from the group consisting of stocking medications according to composition, assigning office locations by job function according to application of medical buildings, and treatment assignment to diagnosis characteristics.

17. The computer program product of claim 15, wherein the labeling the text data extracted from the inquiry comprises collecting a text data corpus of question and answer text from multiple choice questions, and using natural language processing to perform the labeling text data using a model trained with the text data corpus.

18. The computer program product of claim 17, wherein terms selected from the question and answer inquiries include medical topics selected from group consisting of medications and compositions thereof, diagnosis and treatments thereof, medical worker titles and responsibilities thereof, medical building classifications and stock contents thereof, and combinations thereof.

19. The computer program product of claim 15, wherein linking the text to the linking labeled text to the knowledge graph entity comprises a knowledge graph that connects words and phrases of natural language with labeled edges.

20. The computer program product of claim 15, wherein the employing of the remaining relevant knowledge graphs to provide the answer prediction comprises using a beam search to determine a highest confidence reasoning path, and using natural language processing artificial intelligence to make the highest confidence reasoning path the answer prediction in natural language.
